(19) United States
(12) Patent Application Publication
(10) Pub. No.: US 2013/0251879 A1
(43) Pub. Date: Sep. 26, 2013

(54) FOAMING JUICE COMPOSITIONS

(71) Applicants: Deepak Sahai, Dublin, OH (US); Alexander A. Sher, Dublin, OH (US)

(72) Inventors: Deepak Sahai, Dublin, OH (US); Alexander A. Sher, Dublin, OH (US)

(21) Appl. No.: 13/992,173

(22) PCT Filed: Dec. 7, 2011
(86) PCT No.: PCT/EP2011/072018

§ 371 Date: Jun. 6, 2013

Related U.S. Application Data
(60) Provisional application No. 61/420,690, filed on Dec. 7, 2010.

(51) Int. Cl. A23L 2/02

(52) U.S. Cl. CPC A23L 2/02
USPC 426/569

(57) ABSTRACT

The present invention relates to a simple foaming juice composition with a viscosity, clarity or color of the original juice. In one aspect, the invention relates to a foaming juice composition of a juice product and a food grade ester alginate in an amount sufficient to generate or produce a layer of foam thereon without the addition of other foaming agents when the juice product is subjected to agitation without also producing a significant change in viscosity, clarity or color of the juice product. In some embodiments, the ester alginate is a food grade ester alginate, such as propylene glycol alginate ester. In some embodiments, the ester alginate is present in an amount of from about 0.01% to about 0.25%, and preferably from about 0.05% to about 0.1% of the foaming juice composition. The present invention also relates to a method of making a foaming juice composition by combining a juice product with an alginate ester.

### TECHNICAL FIELD

The present invention relates to foaming juice composition which includes a juice product and a food grade additive that generates or produces a layer of foam upon the juice product when subjected to agitation without also producing a significant change in viscosity, clarity or color of the juice product. Preferably the food grade additive is an ester alginate.

### BACKGROUND

Foamed beverage products comprise a large part of the beverage industry with beer, coffee and cola as well known examples. In fact, much work has been done to enhance the foaming properties of these beverages, through both mechanical and additive means. For example, mechanical whipping machines on both the industrial and personal level, are used to aid in the production of froth or foam in cappuccinos, and can be found in many coffee shops and homes throughout the world. Various additives such as dairy products and proteins, dissolved gasses, and colloids have been included to enhance the foaming properties of beverages. These often require large amounts of additives, which can over-complicate, and become large amounts of the total beverage, reducing the amount of the beverage's original makeup. A consumer in today's market is also looking for fewer additives and preservatives in products, in an attempt live healthier lifestyles.

U.S. Pat. No. 4,433,000 describes the use of a combination of propylene glycol alginate (PGAE) and carboxy methyl cellulose (CMC) in a fruit juice formulation in an amount effective as a stabilizer for fruit pulp solids. The patent states that PGAE alone does not stabilize the fruit pulp alone, but no foaming properties of those formulations were described.

U.S. Pat. No. 5,807,603 also describes use of PGAE and CMC in a fruit juice formulation as a stabilizer for fruit pulp solids. The patent states that PGAE and CMC are pre-hydrated and homogenized in the juice that results in use of PGAE and CMC at very low concentrations. The concentration appears to be too low to produce a foamed composition.

International Published WO 2007/064740 describes reduced calorie frozen beverages. The frozen beverages may include fruit extracts or fruit juices and foaming agents including propylene glycol alginate, quillaia, and yucca extract. The patent application exemplifies the use of all three foaming agents in combination.

U.S. Patent Application Publication No. 2010/009052 discloses a foamable liquid oral composition including a high intensity sweetener component and dissolved gas comprising mixture of nitrous oxide and carbon dioxide. The foam-creating composition or beverage composition can contain a juice-based composition. The foaming compositions of this application require a combination of propylene glycol alginate, pectin, gum arabic hydrocolloids for proper performance.

In addition, the specific foam characteristics of a foaming beverage are important. Foams with loose, large bubbles that dissipate too soon are considered poor foams and displeasing to the consumer. Conversely, foams with tiny bubbles that do not dissipate for long periods are also considered poor foams, preventing the user from enjoying the beverage without waiting long periods of time, or forcing the user to consume large quantities of gaseous foam in order to ingest the beverage.

Juices, in general, have poor foaming properties. As such, foamed juice beverages do not encompass a significant portion in the beverage industry. Most foaming juice beverages available center around shakes and smoothies, which require the addition of dairy or other additives, in order to produce the foamed product. Additionally, these shakes and smoothies are more viscous, and have color and/or appearance changes from the fruit juice from which they are produced. Thus, there exists a need for a foamed juice product that has the viscosity, clarity, and color to that of the original juice, but that also produces a pleasing foam that does not dissipate too soon or last too long. Further, there exists a demand in today's market for foamed juice based products with fewer additives in an attempt live healthier lifestyles. The present invention now resolves this need.

### SUMMARY OF THE INVENTION

The present invention now provides the consumer with a simple foaming juice composition with a viscosity, clarity, and color of the original juice. In one aspect, the invention relates to a foaming juice composition comprising a juice product and a food grade ester alginate in an amount sufficient to generate or produce a layer of foam upon the juice product when subjected to agitation without also producing a significant change in viscosity, clarity or color of the juice product.

In some embodiments, the ester alginate is a food grade ester alginate, such as propylene glycol alginate ester. In some embodiments, the ester alginate comprises from about 0.01% to about 0.25% and preferably from about 0.05% to about 0.1% of the foaming juice composition.

In some embodiments, the juice product includes a juice extract, concentrate, granulate, solid, powder, syrup, liquid or a combination thereof.

In some embodiments, the foaming juice composition further comprises diluents such as water, seltzer, or club soda.

In some embodiments, the juice product includes the juice of a fruit or vegetable, such as apple, pear, white grape, red grape, raspberry, blueberry, strawberry, boysenberry, pomegranate, orange, kiwi, watermelon, cantaloupe, honeydew, passion fruit, guava, papaya, mango, banana, pineapple, plum, cherry, tangerine, lemon, lime, apricot, tomato, carrot, celery, beets, spinach or a combination thereof.

In some embodiments, the foaming juice composition consists essentially of about 99.75% to about 99.9% juice product, and about 0.05% to about 0.25% propylene glycol alginate ester.

According to various embodiments, a method for preparing foaming juice composition is described. The method comprises combining a food grade ester alginate in an amount sufficient to generate or produce a layer of foam with a juice product and agitating the alginate containing juice product to generate or produce a layer of foam upon the juice product without also causing a significant change in viscosity, clarity or color of the juice product.

In some embodiments of the method the combining includes whipping, mixing, agitating, shaking, stirring or beating of the juice product and the alginate ester.

In some embodiments of the method the process further includes hydrating the ester alginate in a solution prior to combining with the juice product.

In some embodiments of the method, the ester alginate is hydrated by the juice product during the combination step.

In some embodiments of the method the juice product is formed by the extraction, dehydration, concentration, grinding, granulating, solidifying, powdering, brewing, steeping or a combination thereof, of a juice.

According to various embodiments, the use of a food grade ester alginate to provide a layer of foam upon a juice composition is described. The use is characterized in that the alginate is included in a juice product and the alginate containing juice product is agitated to form the layer of foam upon the juice product without causing a significant change in viscosity, clarity or color of the juice product.

### BRIEF DESCRIPTION OF THE DRAWINGS

Preferred embodiments of the invention, specifically a foaming juice composition can be observed by reviewing the following detailed description and appended drawing figures, wherein:

FIG. 1 is a chart providing the foaming characteristics of a foaming juice composition in accordance with a first embodiment of the invention.

FIG. 2 is a chart providing the foaming characteristics of a foaming juice composition in accordance with another embodiment of the invention.

FIG. 3 is a chart providing the foaming characteristics of a foaming juice composition in accordance with another embodiment of the invention.

### DETAILED DESCRIPTION OF THE INVENTION

The present invention relates to a foaming juice composition comprising a juice product and a food grade ester alginate, wherein the addition of ester alginate generates or produces a layer of foam upon the juice product when subjected to agitation without also producing a significant change in viscosity, clarity or color of the juice product. The foaming juice composition uses few additives in order to produce a foaming juice composition with juice characteristics similar to the original juice.

As used herein, “juice product” refers to a juice composition made wholly of juice. The juice product can be 100% juice, not-from-concentrate, comprising the natural liquid levels of the original fruit or vegetable. Alternatively, the juice product can be a juice extract, concentrate, granulate, solid, powder, or syrup made from non-concentrated juice. Thus, in this instance, the juice product contains lower levels of natural liquid levels—or has an absence of any liquids. The juice product can include the juice of a single fruit or vegetable, or a mixture of one or more fruits and/or vegetables. The juice product can be filtered or may contain natural pulp. The juice product can be heat treated, e.g. pasteurized, UHT treated, retorted, or sterilised.

As used herein, “viscosity” refers to a measure of the resistance of the juice product or juice composition being deformed by either shear stress or tensile stress.

In other words, viscosity refers to the “thickness” or “thinness” of the juice or juice composition. The foaming juice composition should have a viscosity that is similar to a not-from-concentrate juice or the desired viscosity of a reconstituted juice product. If the juice product is made from 100% not-from-concentrate apple juice, then the foamed juice composition should have a similar viscosity to the not-from-concentrate apple juice. Alternatively, if a juice product is a granulate and is hydrated to a specific viscosity prior to forming the foaming juice composition, the foaming juice composition should have a similar viscosity to the hydrated juice product. Viscosity can be measured using a viscometer or rheometer, as known in the art. Viscosity can be described in units in pascal.second (Pa·s) or poise, as known in the art.

As used herein, “clarity” refers to the opaqueness or cloudiness of the juice or juice composition. The foaming juice composition should have a clarity that is similar to a not-from-concentrate juice, or the desired viscosity of a reconstituted juice product. If the juice product is made from 100% not-from-concentrate apple juice, then the foamed juice composition should have a similar clarity to the not-from-concentrate apple juice. Alternatively, if a juice product is a granulate, and is hydrated to a specific clarity prior to forming the foaming juice composition, the foaming juice composition should have a similar clarity to the hydrated juice product. A foamed juice composition should not be significantly clearer than, or cloudier than, the original juice product.

As used herein, “color” refers to the hue of the juice product or juice composition. The foaming juice composition should have a color that is similar to a not-from-concentrate juice product or the color of a reconstituted juice product. If a juice product is subsequently altered with a food grade dye or pigment, then the foamed juice composition should have the color of the dyed juice product. The color of a foamed juice composition should be similar to the original juice product. The color of the juice product or foamed juice composition may be measured using a colorimeter in order to provide a quantifiable measurement, as known in the art.

As used herein, “similar” refers to limited differences between a physical characteristic of the juice product and the foamed juice composition. If a physical characteristic, such as viscosity, clarity or color has a specific quantifiable measurement, that measurement should be the same, or nearly the same, between the juice product (not-from-concentrate or hydrated) and the foamed juice composition. Some amount of variation is permitted. Preferably, a quantifiable measurement, such as viscosity should not have more than a 20% difference between the juice product and the foamed juice composition. More preferably, a quantifiable measurement should not have more than a 10% difference between the juice product and the foamed juice composition. Even more preferable, a quantifiable measurement should not have more than less than about a 5% difference between the juice product and the foamed juice composition. Alternatively, a juice product with a red color, should not result in a foamed juice composition with a white color. Slight changes with respect to shades of a color may be permitted.

As used herein “significant” refers to large differences between a physical characteristic of the juice product of foamed juice composition. If a physical characteristic, such as viscosity, clarity or color has a specific quantifiable measurement, that measurement should be the same, or nearly the same, between the juice product (not-from-concentrate or hydrated) and the foamed juice composition. There should not be a significant difference between the two measurements. Some amount of variation is permitted. Preferably, a quantifiable measurement, having more than a 20% difference between the juice product and the foamed juice composition would be considered a “significant” difference. More preferably, a quantifiable measurement having more than a 10% difference between the juice product and the foamed juice composition would be considered a “significant” difference. Even more preferable, a quantifiable measurement having more than about a 5% difference between the juice product and the foamed juice composition would be considered a “significant” difference. Alternatively, a starting juice product with a thick viscosity similar to honey would be considered significantly different than a final foamed juice composition having a low viscosity similar to water. As used herein, “low” refers to a viscosity of 20 mPa·s or less, preferably a viscosity of 10 mPa·s or less, more preferably a viscosity of less than 5 mPa·s or less, and preferentially, a viscosity of 2 mPa·s or less. Viscosity can be measured with an Anton Paar Physica MCR 501 rheometer at 75 s⁻¹ at room temperature (25° C.). Viscosity of water is about 1.002 mPa·s at 20° C. Likewise, a starting juice product with a red color would be considered significantly different than a final foamed juice composition having a pink color.

As used herein, “comprising,” “is,” “are,” “including,” “containing,” “characterized by,” and grammatical equivalents thereof are inclusive or open-ended terms that do not exclude additional, unrecited elements or method steps. “Comprising” is to be interpreted as including the more restrictive terms “consisting of” and “consisting essentially of.”

A surprising feature of the foaming juice composition is the relative simplicity and limited number of the ingredients of the foaming juice composition. In a preferred embodiment the compositions may consist essentially of or even consist of a juice product or juice and a food grade ester alginate. The foaming juice composition can contain from about 1% to about 99.99% by weight of the juice product. Preferably, the foaming juice composition can contain from about 75% to about 99.99% by weight of the juice product. Most preferably, the foaming juice composition can contain from about 99.75% to about 99.99% by weight of the juice product. Conversely, the foaming juice composition can contain about 0.01% to about 0.25% by weight of the food grade ester alginate. Preferably, the foamed juice composition can comprise from about 0.05% to about 0.1% ester alginate.

As mentioned above, the juice product can be 100% juice, not-from-concentrate or can be a juice extract, concentrate, granulate, solid, powder, or syrup made from non-concentrated juice. The juice product can include the juice of a fruit or vegetable. The fruits or vegetables that can be used in the fruit product can include, but is not limited to, apples, pears, white grapes, red grapes, raspberries, blueberries, strawberries, boysenberries, pomegranates, oranges, kiwis, watermelons, cantaloupes, honeydews, passion fruit, guavas, papayas, mangos, bananas, pineapples, plums, cherries, tangerines, lemons, limes, apricots, tomatoes, carrots, celery, beets, spinach, or a combination thereof.

The foaming properties of the foaming juice composition are derived from the presence of food grade ester alginates. Alginates or alginic acid can be natural or synthetic. Sources of natural alginates can be derived from seaweeds such as Ascophyllum, Durvillaea, Ecklonia, Laminaria, Lessonia, Macrocystis, Sargassum and Turbinaria. Synthetic alginates include propylene glycol alginate. Preferably, the food grade ester alginate is PGAE (Supplier: FMC Biopolymers, Inc.). One or more alginate esters may be used in a foaming juice composition. Preferably, the food-grade alginate is an ester alginate, such as propylene glycol alginate ester.

Esterification occurs at the carboxylic acid groups on the alginate chain, mainly with the primary hydroxyl group. Depending on reaction conditions, varying degrees of esterification can be achieved. The food grade ester alginate may be about 60-70% esterified, but may be up to about 90% esterified depending upon the fruit juice composition and the desired foaming characteristics of the fruit juice composition.

The ester alginate can be provided in powdered form and may be hydrated prior to combination with the juice product, or may be hydrated by the juice product. Alternatively, the ester alginate may be partially hydrated prior to combination with the juice product, and only fully hydrated when combined with the juice product. A skilled artisan would be able to determine the required hydration of the ester alginate, depending upon the desired final foamed juice composition.

In some embodiments, the foamed juice composition can include diluents separate from the juice product or the alginate ester. The diluents can be, but are not limited to, water and carbonated beverages, such as club soda or seltzer. The addition of diluents should not significantly alter the foaming properties. For certain embodiments, the sole source of water in the foamed juice composition may possibly be derived from the water present in the juice itself or alternatively, the sole source of water may comprise added water.

The temperature of the foamed juice composition can vary. The foamed juice product can be a hot, an ambient, a cold or a chilled beverage. In these embodiments, the juice product or the diluent can be heated prior to combination with the alginate ester, and the foamed juice product can subsequently be chilled over ice to produce a cold beverage. Alternatively, the juice product or the diluent can be chilled or refrigerated prior to combination with the alginate ester to produce a cold beverage.

The use of alginates in the food industry has been known for years and alginates in particular are often used for their foaming, stabilization, and thickening properties in beverages. It was a surprising discovery that low quantities of ester alginates are capable of producing foamed juice compositions without altering the viscosity, clarity, or color of the foamed juice product in comparison to the juice product.

Aqueous mixtures of juice products in graduated (i.e., measured) flasks, cylinders, or tubes, with or without 0.1% by weight of PGAE or other hydrocolloids, can be tested for foaming characteristics. Using commercially available whipping or mixing machines, aqueous mixtures can be mechanically foamed. Noting the height of the aqueous mixture prior to mixing, and comparing it to the height of the top of the foam after mixing, one can determine a “whippability index” for the foamed juice product. The “whippability index” is the air to liquid ratio of the foamed composition. A foamed juice composition having a whippability index above of at least 0.3% or greater and preferably about 0.4% to 0.5% or higher would be considered to be a foamable composition.

The stability of the foam can also be measured. Once foamed, the duration of the foam head, (i.e., how long the foam lasts on top of the juice) can be timed. An aqueous mixture subjected to whipping can be set aside and left undisturbed for a period of time. Preferably, the foam is measured in one minute (60 second) intervals. Foams that are able to be maintained for more than several minutes are considered to be a foamable juice composition. Foams that immediately deflate within the first minute are considered to be poor foamable juice compositions.

Because the foaming capability of the foamed juice compositions is derived from food grade alginate esters, the act of foaming can be made using any suitable mechanical agitation. For example, the foam can be produced by agitating a mixture of the juice product and the alginate ester by whipping, mixing, agitating, shaking, stirring or beating the aqueous mixture. The mixing can be done using impellers, blades, discs, paddles, or high pressure streams of the liquid(s). The mixing can occur in whipping chambers, in-cup mixers, or even in packaging containing the premixed ingredients. For example, the foaming juice product can be dispensed from conventional food service machines by pouring or preferably by using spray nozzles that eject the juice product and the alginate ester into a container or cup to produce the foamed juice composition.

The mixing of the foamed juice composition can be done with the juice product and alginate ester mixed together prior to foaming. Alternatively, the foamed juice composition can be made by first foaming the juice product, then foaming the alginate ester, and then combining the two foamed products. It was surprising and unexpected that a higher quality foam is produced by combining the juice product and the alginate ester prior to foaming versus foaming the individual components, and then combining.

In some embodiments, the foamed juice compositions can be distributed as ready-to-drink composition with appropriate packaging. Such packaging would allow the foaming juice composition to not foam until ready to be consumed, by separating the juice product from the ester alginate until immediately prior to consumption, at which time the user applies agitation to the product to produce the foam. In alternate embodiments, the act of opening the sealed packaging provides sufficient agitation to produce the foam. In another embodiment, pouring the aqueous mixture containing the juice product and alginate ester into a container, such as a glass or cup provides sufficient agitation to produce the foam. In alternate embodiments, the mixture of juice product and ester alginate is distributed via airtight pressurized containers, such as aluminium cans, PET bottles, glass bottles, and the like. Such containers may be pressurized with gasses such as carbon dioxide or nitrogen. The foaming composition is then agitated sufficiently as it is dispensed via a tap or a spigot.

In another embodiment, the foamed juice compositions can be distributed as individual components (a juice product and an alginate ester) to be mixed locally by the end user in a food service machine. In such embodiments, the juice product may be distributed as a concentrate (granulate, powder, syrup, etc.) and the alginate ester can be distributed as a concentrate (granulate, powder, syrup, gel, etc.). The end user can then dilute the juice product and the alginate ester appropriately, provide the required agitation and produce the foamed juice composition. Such separate packing can be integrated into standard food service machines found in offices and homes alike. Further, individual packets can be distributed to consumers, which allows a user to dilute the juice concentrate and alginate ester in an appropriate amount of diluents (such as the water in an individual water bottle), mix the ingredients appropriately and form the juice product. Thus, the juice composition may be distributed in cans, jars, boxes, kegs, packets or other means known in the art.

### EXAMPLES

The following examples are given by way of illustration only and are not intended to limit the scope of the invention in any way.

### Example 1

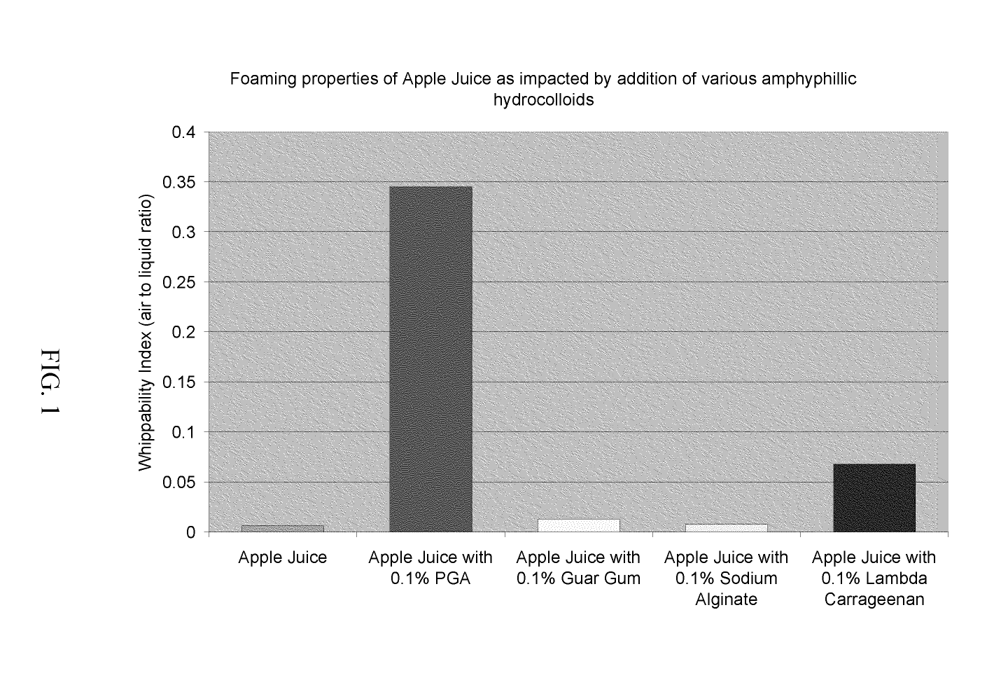

### Tests Determining the Foaming Characteristics of Apple Juice with Various Amphyphillic Hydrocolloids for their Foaming Capabilities is Presented in FIG. 1 and Table 1 Below

TABLE 1

| Juice | Hydrocolloid |
|---|---|
| Apple Juice | N/A |
| Apple Juice | 0.1% PGAE |
| Apple Juice | 0.1% Guar Gum |
| Apple Juice | 0.1% Sodium Alginate |
| Apple Juice | 0.1% Lambda Carrageenan |

100 mLs of 100% apple juice with either 0.1% PGAE, guar gum, sodium alginate, or lambda carrageenan was dispensed into a graduated cylinder (250 ml) through a beverage dispenser with a whipper such that the beverage was whipped at 5000 rpm for 15 seconds while dispensing. The height of the aqueous mixture was measured pre- and post-whipping. The whipped mixture was allowed to stand undisturbed and the volume of the foam measured after 1 and 5 minutes to observe foam stability. As can be seen in FIG. 1, only the composition having apple juice and 0.1% by weight PGAE showed significant foaming characteristics.

### Example 2

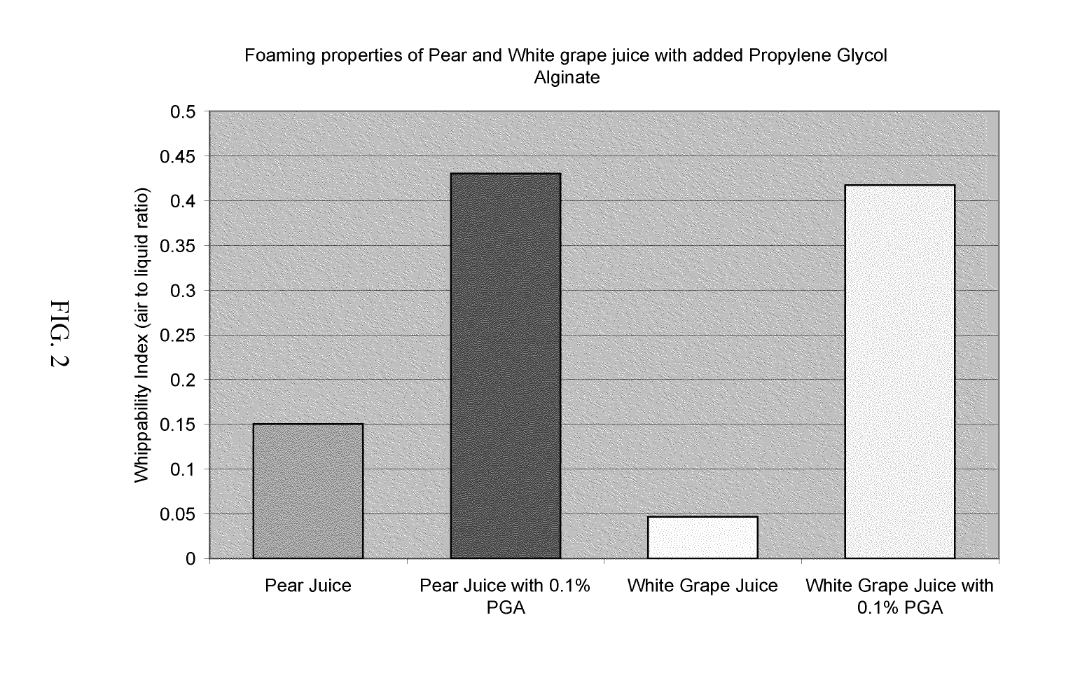

### Tests Determining the Foaming Characteristics of Pear Juice and White Grape Juice with 0.1% PGAE for their Foaming Capabilities is Presented in FIG. 2 and Table 2 Below

TABLE 2

| Juice | Alginate Ester |
|---|---|
| Pear Juice | 0.1% PGAE |
| Pear Juice | N/A |
| White Grape Juice | 0.1% PGAE |
| White Grape Juice | N/A |

100 mLs of aqueous mixtures of 100% pear juice with 0.1% PGAE or 100% white grape juice was dispensed into a graduated cylinder (250 ml) through a beverage dispenser with a whipper such that the beverage was whipped at 5000 rpm for 15 seconds while dispensing. The height of the aqueous mixture was measured pre- and post-whipping. The whipped mixture was allowed to stand undisturbed and the volume of the foam measured after 1 and 5 minutes as an indicator of foam stability. As can be seen in FIG. 2, the compositions having pear juice or white grape juice and 0.1% by weight PGAE showed significant foaming characteristics. Conversely, tests on pear juice or white grape juice alone show that the juices are incapable of producing a suitable foamed composition.

### Example 3

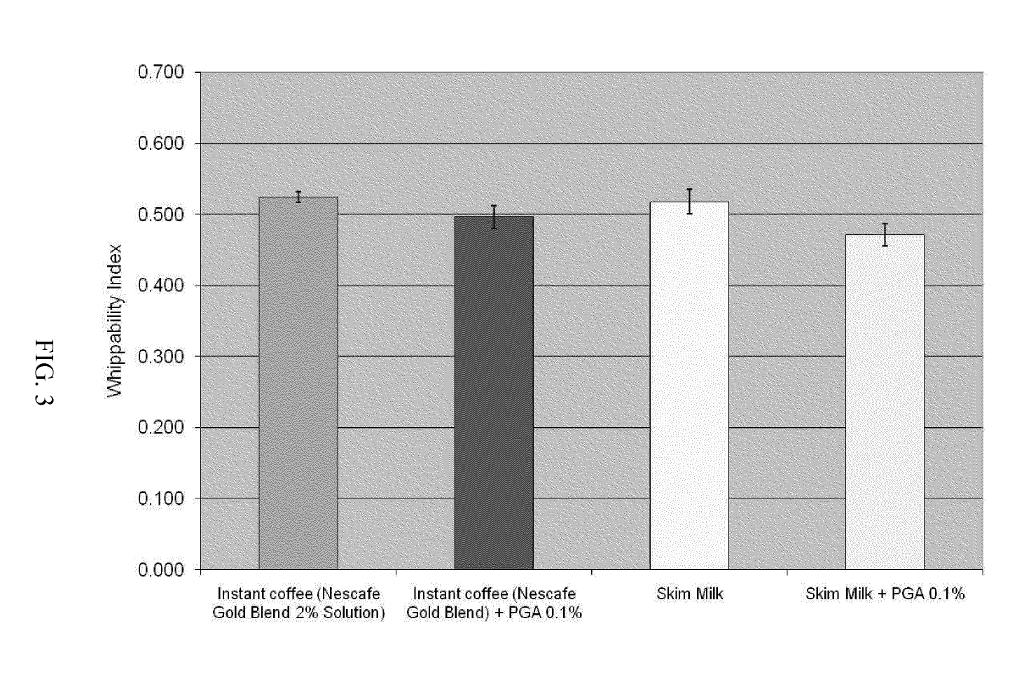

### Tests Showing the Surprising Foaming Characteristics of Beverages with 0.1% PGAE is not Universal is Presented in FIG. 3 and Table 3 Below

TABLE 3

| Beverage | Alginate Ester |
|---|---|
| Coffee | 0.1% PGAE |
| Skim Milk | 0.1% PGAE |

100 mLs of aqueous mixtures of coffee (2% solution) with 0.1% PGAE or skim milk with 0.1% PGAE was dispensed into a graduated cylinder (250 ml) through a beverage dispenser with a whipper such that the beverage was whipped at 5000 rpm for 15 seconds while dispensing. The height of the aqueous mixture was measured pre- and post-whipping. The whipped mixture was allowed to stand undisturbed and the volume of the foam measured after 1 and 5 minutes as an indicator of foam stability. As can be seen in FIG. 3, the compositions having coffee and 0.1% by weight PGAE or skim milk and 0.1% by weight PGAE showed no significant improvements to foaming characteristics. Further tests supported this observation in that similar results were found for other beverages.

It was surprising to discover that low amounts of alginate esters were capable of producing superior foaming capabilities to juice products. It was even more surprising that the combination of juice product and alginate ester produces a better quality foam than if one foams the juice product separately from the alginate ester, and then mixes them together, suggesting a synergistic relationship. It was also surprising and unexpected that the addition of other constituents into the compositions could render the aqueous mixture of juice product and alginate ester incapable of foaming. It was even more surprising and unexpected that not all liquid beverages were capable of being foamed. As such, the addition of other constituents should be test for their effects on the foaming characteristics of the juice composition.

Various additives may be included in the aqueous mixture of the juice product and the alginate ester. For example, food grade dyes, flavorants, preservatives, sweeteners, etc., may be added into the mixture. Further, the aqueous mixtures can be fortified with vitamins, minerals, antioxidants, probiotics, or prebiotics, etc. The foaming juice composition can be caffeinated or decaffeinated. However, appropriate amounts and concentrations of the additives must be tested in order to determine their additive effect on the foaming properties of the composition. A skilled artisan, using the techniques described herein, would be able to produce such foaming juice compositions.

While illustrative aspects in accordance with the present invention are disclosed herein, it will be appreciated that numerous modifications and other embodiments can be devised by those of ordinary skill in the art. The aspects described herein can be combined, separated, interchanged, and/or rearranged to generate other embodiments. Therefore, it will be understood that the appended claims are intended to cover all such modifications and embodiments that come within the spirit and scope of the present invention. Many variations and modifications will be apparent to those of ordinary skill in the art.

1. A foaming juice composition comprising:
a juice product; and
a food grade ester alginate present in the juice product in an amount sufficient to generate or produce a layer of foam thereon without the addition of other foaming agents when the juice product is subjected to agitation without also producing a significant change in viscosity, clarity or color of the juice product.

2. The foaming juice composition of claim 1, wherein the ester alginate is a food grade ester alginate and the composition has a whippability index of at least 0.3, 0.4, 0.5 or greater.

3. The foaming juice composition of claim 1, wherein the ester alginate comprises from about 0.01% to about 0.25% of the foaming juice composition.

4. The foaming juice composition of claim 1, wherein the juice product includes a component selected from the group consisting of a juice extract, concentrate, granulate, solid, powder, syrup, liquid and combinations thereof.

5. The foaming juice composition of claim 1 comprising a diluent.

6. The foaming juice composition of claim 1, wherein the juice product includes the juice of a fruit or vegetable.

7. The foaming juice composition of claim 1, consisting essentially of about 99.75% to about 99.9% juice product, and about 0.05% to about 0.25% propylene glycol alginate ester.

8. A process of making a foaming juice composition, comprising:
combining a food grade ester alginate with a juice product, wherein the alginate is added in an amount sufficient to generate or produce a layer of foam thereon without the addition of other foaming agents when the juice product is subjected to agitation; and
agitating the alginate containing juice product to generate or produce a layer of foam thereon without also causing a significant change in viscosity, clarity or color of the juice product.

9. The process of claim 8, wherein the combining includes a step selected from the group consisting of whipping, mixing, agitating, shaking, stirring, and beating of the juice product and the alginate ester.

10. The process of claim 8, wherein the process includes hydrating the ester alginate in a solution prior to combining with the juice product.

11. The process of claim 8, wherein the ester alginate is hydrated by the juice product during the combination step.

12. The process of claim 8, wherein the juice product is formed by a step selected from the group consisting of extraction, dehydration, concentration, grinding, granulating, solidifying, powdering, brewing, steeping, and combinations thereof, of a juice.

13. The process of claim 8, wherein the ester alginate is a food grade ester alginate.

14. The process of claim 8, wherein the ester alginate comprises from about 0.01% to about 0.25%, of the foaming juice composition.

15. The process of claim 8, wherein the juice product includes a component selected from the group consisting of a juice extract, concentrate, granulate, solid, powder, syrup, liquid and combinations thereof.

16. A method of providing a layer of foam upon a juice composition, comprising the step of adding a food grade ester alginate to a juice product in an amount sufficient to generate or produce a layer of foam thereon without the addition of other foaming agents when the juice product is subjected to agitation to form the layer of foam upon the juice product without causing a significant change in viscosity, clarity or color of the juice product.
